(19) United States
(12) Patent Application Publication
(10) Pub. No.: US 2023/0173596 A1
(43) Pub. Date: Jun. 8, 2023

(54) SAW ANGLE GAGE

(71) Applicant: Jerry T. Livers, Graham, NC (US)

(72) Inventor: Jerry T. Livers, Graham, NC (US)

(21) Appl. No.: 17/643,245

(22) Filed: Dec. 8, 2021

(51) Int. Cl. B23D 59/00; G01B 7/305

(52) U.S. Cl. CPC B23D 59/002; G01B 7/305

(57) ABSTRACT

A saw angle gage is a square or rectangular shaped platform with two (2) electrical contacts attached to one of the four sides of the platform. A battery and a light are mounted to the platform and wired together with the two (2) electrical contacts forming an isolated electrical circuit that is open between the two (2) electrical contacts. When both of the electrical contacts touch a current conducting object, the light will illuminate. When both electrical contacts touch a current conducting object and the full length of one of the adjacent sides of the platform touches a different object, the light will illuminate, indicating a right-angle relationship between the objects. When both electrical contacts touch a current conducting object and the full length of the opposite side of the platform touches a different object, the light will illuminate, indicating a parallel relationship between the objects.

The present invention relates to a power tool accessory that uses electrical current and a light source to verify whether or not a right-angle or parallel relationship exists between key components of wood cutting machinery like chop saws, miter saws, table saws, jointers, etc.

### BACKGROUND OF THE INVENTION

Woodworking projects frequently require cutting of parts that must fit together with precision. Powered cutting equipment used to produce the wood parts usually have adjustable components such as cutting blades and fences. These cutting blades and fences may drift off the intended cutting angle with usage or the equipment may arrive new from the manufacturer with the cutting blades or fences out of alignment.

The process of checking and/or adjusting cutting angles in powered wood cutting equipment in common practice today is repetitive. The operator will typically cut several pieces of wood and then visually check how the pieces fit together. If the result is inaccurate, manual adjustments are made to the cutting saw blade or fence. Corrections to the cutting angle may not be completely accurate because the adjustment is visual in nature, involving the use of squares or protractors, and accuracy can be affected by lighting and vision issues. After corrections are made, several additional pieces of wood are cut and checked. This process repeats until the pieces of wood fit together as desired. This process results in unnecessary lost time and materials.

### BRIEF SUMMARY OF THE INVENTION

Briefly described, the saw angle gage of the preferred embodiment of the present invention includes a platform that may be of different sizes to fit commercially available powered wood cutting equipment.

In all forms of the preferred embodiment of the present invention the saw angle gage platform has four sides which are at right angles to each other.

In all forms of the preferred embodiment of the present invention, several electrical components are attached to the platform, consisting of: One (1) battery, one (1) light, two (2) electrical contacts and miscellaneous electrical wire. The battery and light are embedded in or on the top of the platform. The two (2) electrical contacts are attached to and spaced apart on one side of the platform. The battery, light and electrical contacts are wired to form an isolated electrical circuit that is open between the two (2) electrical contacts. The light will illuminate when both electrical contacts are touching an electricity conducting surface like a steel cutting blade, a steel fence or a steel baseplate of wood cutting equipment.

When both electrical contacts touch a current conducting object and the full length of one of the adjacent sides of the platform touches a different object, the light will illuminate, indicating a right-angle relationship between the objects. When both electrical contacts touch a current conducting object and the full length of the opposite side of the platform touches a different object, the light will illuminate, indicating a parallel relationship between the objects.

### BRIEF DESCRIPTION OF THE DRAWINGS

The preferred embodiment of the present invention is described herein in detail, with reference to the following figures, wherein:

FIG. 1 is a perspective view of the saw angle gage depicting its platform 1 and electrical components 2-8 attached thereto.

FIG. 2 is a plan view of the saw angle gage depicting its platform 1 and electrical components 2-8 attached thereto.

FIG. 3 is an illustration of using the saw angle gage with a chop or miter saw, depicting side b of platform 1 placed against fixed fence 9 with only electrical contact 7 touching adjustable circular cutting blade 10.

FIG. 4 is an illustration of using the saw angle gage with a chop or miter saw depicting side b of platform 1 placed against fixed fence 9 with both electrical contacts 6 and 7 touching adjustable circular cutting blade 10.

FIG. 5 is an illustration of using the saw angle gage with a jointer depicting side b of platform 1 placed against fixed base plate 11 with only electrical contact 7 touching adjustable fence 12.

FIG. 6 is an illustration of using the saw angle gage with a jointer depicting side b of platform 1 placed against fixed base plate 11 with both electrical contacts 6 and 7 touching adjustable fence 12.

FIG. 7 is an illustration of using the saw angle gage with a table saw depicting side c of platform 1 placed against circular cutting blade 10 with only electrical contact 7 touching adjustable fence 12.

FIG. 8 is an illustration of using the saw angle gage with a table saw depicting side c of platform 1 placed against circular cutting blade 10 with both electrical contacts 6 and 7 touching adjustable fence 12.

FIG. 9 is a photo perspective view of a homemade saw angle gage placed on a sliding chop/miter saw.

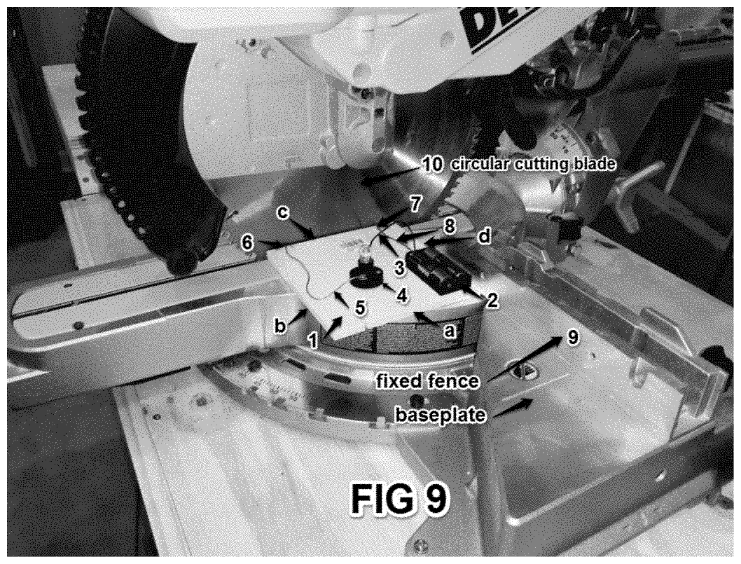

### DETAILED DESCRIPTION OF THE PREFERRED EMBODIMENT OF THE PRESENT INVENTION

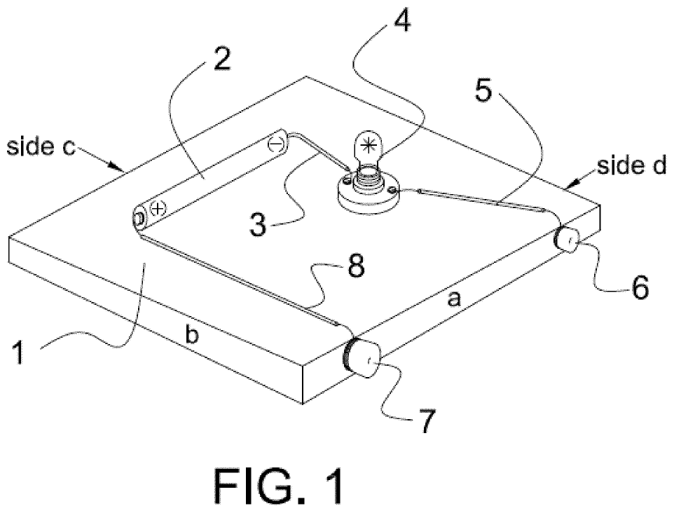

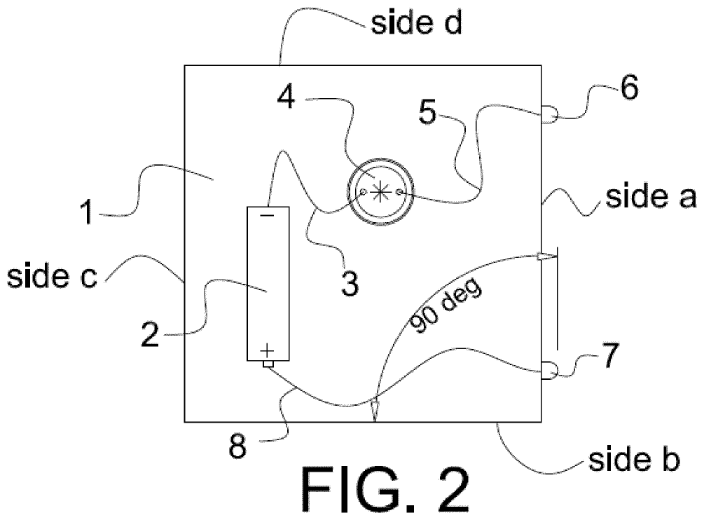

The saw angle gage, as depicted in FIG. 1 and FIG. 2 consists of a four-sided platform 1, battery 2, electrical wires 3,5 and 8, light 4 and electrical contacts 6 and 7. The battery 2 and light 4 are attached to or embedded in the top surface of platform 1. The electrical contacts 6 and 7 are attached to side a of platform 1. Wire 3 connects battery 2 to the light 4. Wire 5 connects the light 4 to electrical contact 6. Wire 8 connects electrical contact 7 to battery 2.

A line drawn between the tip of electrical contact 6 and the tip of electrical contact 7 forms a right angle with respect to side b and side d of platform 1. A line drawn between the tip of electrical contact 6 and the tip of electrical contact 7 is parallel with side c of platform 1.

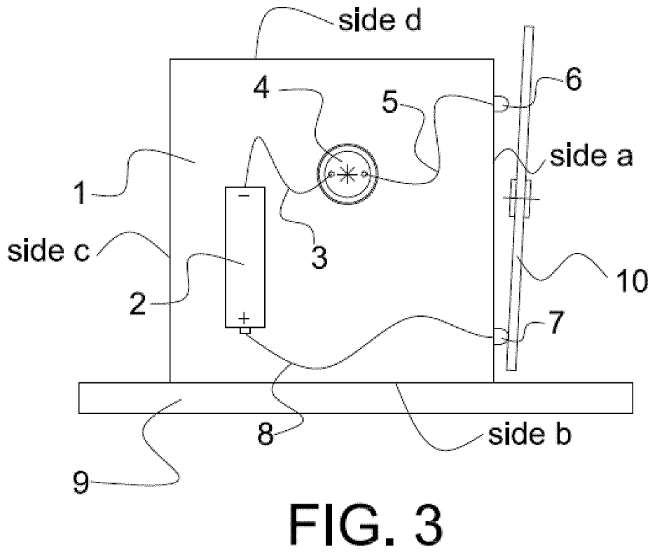

In FIG. 3 when using the saw angle gage with a chop or miter saw, side b of platform 1 of the saw angle gage is held against fixed fence 9 and only electrical contact 7 touches circular cutting blade 10. Light 4 will not illuminate, indicating fixed fence 9 and circular cutting blade 10 are not at a right angle with respect to each other.

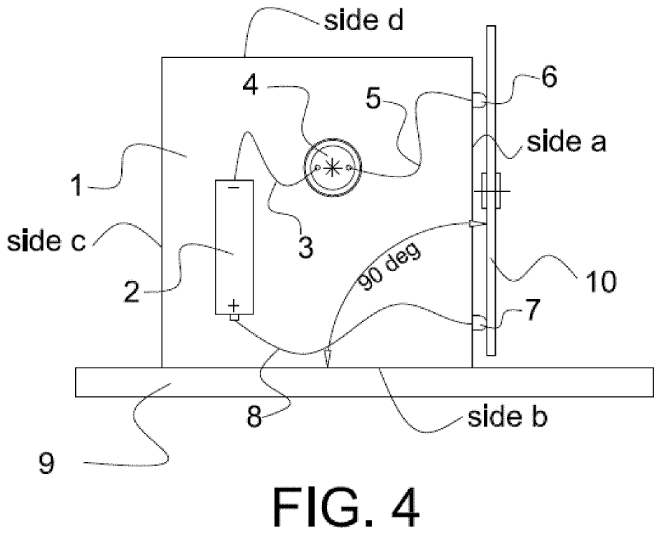

In FIG. 4 when using the saw angle gage with a chop or miter saw, side b of platform 1 of the saw angle gage is held against fixed fence 9 and both electrical contacts 6 and 7 touch circular cutting blade 10. Light 4 will illuminate, indicating fixed fence 9 and circular cutting blade 10 are at a right angle with respect to each other.

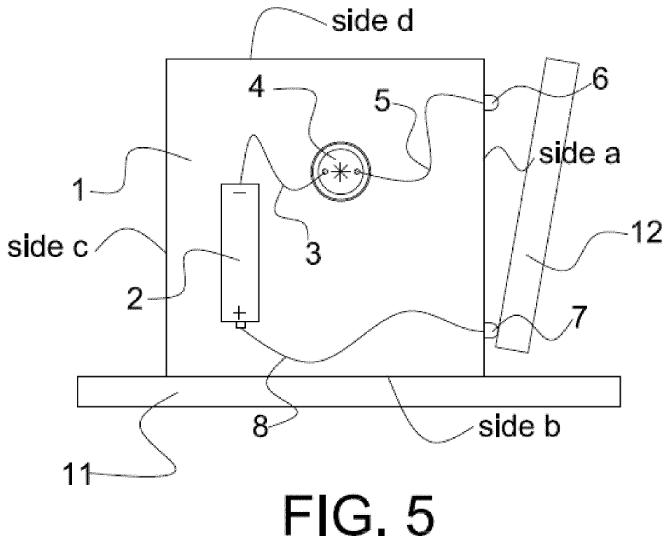

In FIG. 5 when using the saw angle gage with a wood jointer, side b of platform 1 of the saw angle gage is held against fixed baseplate 11 and only electrical contact 7 touches adjustable fence 12. Light 4 will not illuminate, indicating fixed baseplate 11 and adjustable fence 12 are not at a right angle with respect to each other.

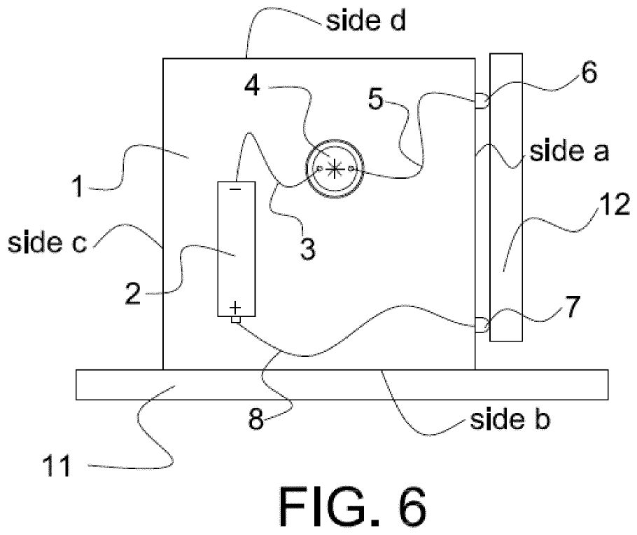

In FIG. 6 when using the saw angle gage with a wood jointer, side b of platform 1 of the saw angle gage is held against fixed baseplate 11 and both electrical contacts 6 and 7 touch adjustable fence 12. Light 4 will illuminate, indicating fixed baseplate 11 and adjustable fence 12 are at a right angle with respect to each other.

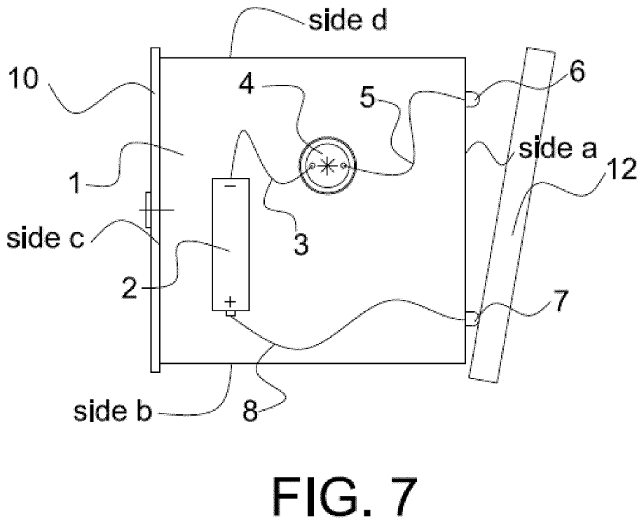

In FIG. 7 when using the saw angle gage with a table saw, side c of platform 1 of the saw angle gage is held against fixed circular cutting blade 10 and only electrical contact 7 touches adjustable fence 12. Light 4 will not illuminate, indicating fixed cutting blade 10 and adjustable fence 12 are not at a right angle with respect to each other.

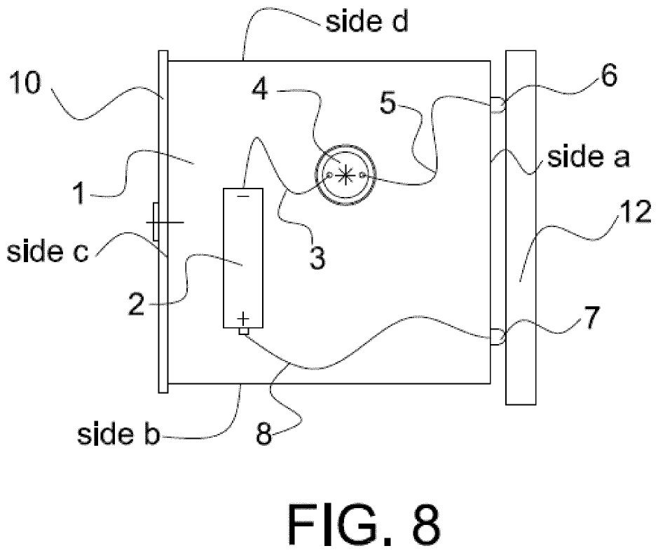

In FIG. 8 when using the saw angle gage with a table saw, when side c of platform 1 of the saw angle gage is held against fixed circular cutting blade 10 and both electrical contacts 6 and 7 touch adjustable fence 12, light 4 will illuminate, indicating fixed circular cutting blade 10 and adjustable fence 12 are at a right angle with respect to each other.

What is claimed:

1. A saw angle gage comprised of:
a platform
a battery
a light
two (2) electrical contacts
electrical wiring
wherein each of the four sides of the platform are at a right angle with respect to each adjacent side of the platform; the battery and light are affixed to the top of or embedded within the platform and the two (2) electrical contacts are spaced apart and attached to one side of the platform. A straight line drawn between the tip of each of the two (2) electrical contacts is at a right angle to each of the adjacent sides of the platform and is parallel with the opposite side of the platform. The electrical components and wiring form an isolated electrical circuit that is open between the two (2) electrical contacts; the purpose of which is to only illuminate the light when both of the contacts are touching a current conducting object.
